(19) United States
(12) Patent Application Publication
(10) Pub. No.: US 2015/0143941 A1
(43) Pub. Date: May 28, 2015

(54) METHOD FOR RELEASING OR BLOCKING THE FUNCTION OF STEERING WHEEL OR STEERING COLUMN SWITCHES ON A CASE-BY-CASE BASIS, AND MOTOR VEHICLE HAVING STEERING WHEEL AND STEERING COLUMN SWITCHES

(71) Applicant: FORD GLOBAL TECHNOLOGIES, LLC, Dearborn, MI (US)

(72) Inventors: Thomas Oeltjebruns, Dormagen (DE); Uwe Thiesmeyer, Cologne (DE)

(21) Appl. No.: 14/405,457

(22) PCT Filed: Jun. 3, 2013
(86) PCT No.: PCT/EP2013/061340

§ 371 Date: Dec. 4, 2014

(30) Foreign Application Priority Data
Jun. 6, 2012 (DE) 10 2012 209 584.5

(51) Int. Cl. G05G 5/00; B62D 1/04; B62D 1/16

(52) U.S. Cl. CPC G05G 5/005; B62D 1/16; B62D 1/04
USPC 74/484 R

(57) ABSTRACT

The invention relates to a method for case-based enabling or disabling of the function of steering wheel or steering column switches in a motor vehicle. According to the invention, at least one function of one of the steering wheel or steering column switches is enabled or disabled depending on the operation of another steering wheel or steering column switch.

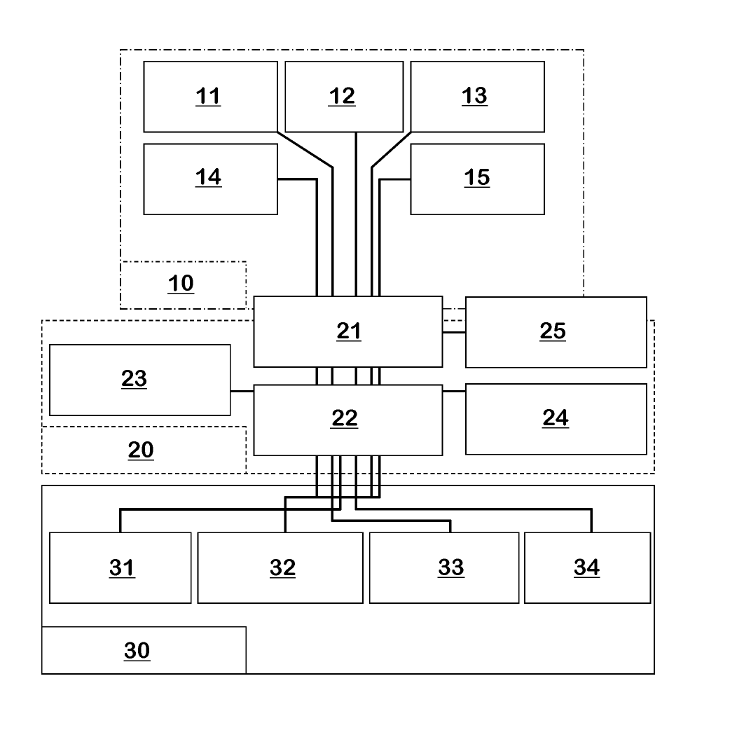

The invention relates to a method for the case-based enabling or disabling of the function of steering wheel or steering column switches in a motor vehicle, and a motor vehicle with steering wheel and steering column switches according to the preamble of the independent claims.

It is known from DE 102 11 825 A1 to enable or disable the function of steering wheel or steering column switches in a motor vehicle on a case basis, i.e. depending on a steering angle of the steering wheel detected with a steering angle sensor or on the speed with which the steering wheel is turned, in order to prevent incorrect operations in certain driving situations.

The object of the present invention is to provide a method with which the function of steering wheel or steering column switches can be enabled or disabled independently of the current steering angle in certain driving situations in which there is a risk of incorrect operations.

This object is achieved by a method and a motor vehicle according to the independent claims. Advantageous developments of the invention are specified in the dependent claims.

According to the invention, there are certain dependencies and priorities of steering wheel and steering column switches on each other and relative to each other, in that switch functions are enabled or disabled according to certain priorities, and this is preferably independent of the steering angle.

The invention is based on the knowledge that, with the number of switches on the steering wheel and steering column of modern motor vehicles, which are now disposed on the steering wheel rather than on the steering column, it can be advantageous to enable or to disable the function of some steering wheel or steering column switches that are at risk of incorrect operation not depending, or not only depending, on the current steering angle, but depending on the operation of another steering wheel or steering column switch.

For example, there are steering wheels that support gearshift paddles for upshifting and downshifting, which can (also) be operated by pulling with the finger. It can be the case that while driving straight or while turning such a gearshift paddle lies within an angular range of the steering wheel in which steering column switches are disposed (a more or less long lever protruding from the steering column), with which the headlight flasher or a rapid windscreen cleaning function is operated by the driver pulling the corresponding steering column switch towards him. Of course, such steering column switches are designed so that they preferably cannot touch any switch provided on the steering wheel, but especially the headlight flasher and the rapid windscreen cleaning function are often operated in situations in which the driver has to react quickly and therefore grabs them more powerfully than actually necessary for safety reasons.

It may happen that a steering column switch is pulled excessively because of its natural elasticity and thus a gearshift paddle is also operated at the same time, either by contact with the steering column switch itself or by contact with the fingers of the hand that is operating the steering column switch. However, disabling the gearshift paddle depending on the steering angle would excessively restrict the driver's control over the vehicle.

The invention is also suitable for other combinations of switches on the steering wheel and steering column, especially for those for which the function of a steering wheel switch is enabled or disabled depending on the operation of one or a plurality of steering column switches.

The term “switch”, as used herein, is not only intended to include switch elements with a plurality of stable switch states, but also push-buttons with only one stable switch state. In any case the disabling of the corresponding switch function starts at the instant at which the driver operates the disabling switch. If said case-based disabled switch has only one stable switch state, its disablement preferably ends at a predetermined time—such as e.g. 1 second—after no further operating signal has been received from the disabling switch. Unintended triggering usually occurs less readily in the case of a switch with a plurality of stable switch states, but it can be advantageous to also temporarily disable its function(s) depending on the circumstances in the vehicle.

One embodiment, in which the at least one function of one of the steering wheel or steering column switches is disabled and enabled independently of the current steering angle of the steering wheel, is particularly suitable for vehicles having no steering angle sensor, but also for vehicles with a steering angle sensor disposed remotely from the steering wheel and the steering column, because in this case the hardware and software combination would be complex.

However, for motor vehicles in which a suitable steering angle sensor is present, its steering angle signal can also be used within the scope of the invention. For example, disabling the function of a steering wheel switch depending on the operation of a steering column switch can also be carried out depending on whether said steering wheel switch is close to said steering column switch or not for the current steering angle, i.e. whether there is actually a risk of incorrect triggering or not for said steering angle. This enables certain unintended switch interactions to be specifically excluded without completely inhibiting operability for all steering angles or for a wide range of steering angles. For motor vehicles with steering angle sensors, with which a function of a steering wheel or steering column switch is enabled or disabled only depending on the steering angle, switch disabling must be carried out in wide angular ranges for safety reasons.

The invention is particularly advantageous in cases in which at least one or each switch having a function that is enabled or disabled by the operation of one of the other switches is disposed behind the steering wheel and can be operated by the driver and is especially disposed on the rear side of the steering wheel, such as e.g. in the case of a gearshift paddle, because in such cases there is a particularly likely risk of incorrect triggering. The invention can, however, also be useful with other steering wheel switches, e.g. with control switches for a car radio, a multimedia device, an on-board computer or a cruise control system, which e.g. can be disposed on the front of the spokes of the steering wheel. For example, some drivers are inclined to operate the audible horn by striking the steering wheel with the whole hand, whereby said control switches can also be triggered. This can be prevented with the invention.

However, the invention is expected to be most useful in cases in which the function of a steering column switch that is disposed on the rear of the steering wheel or that is to be operated from behind the steering wheel is disabled by a steering column switch, especially for flashers, a headlight flasher or a rapid windscreen cleaning function.

In one preferred embodiment, the disabling or enabling of switch functions is carried out by processing signals of the steering wheel switch or steering column switch within the steering column. By processing close to the switch the response time can be very short. In this case the invention is preferably implemented by means of a signal processing and/or data processing module in the steering column, which is arranged to receive signals from at least one steering wheel or steering column switch, to at least partly process the same and to forward the same to a vehicle electronics unit or not depending on an operation of another steering wheel switch or steering column switch.

However, the disabling or enabling by means of the processing of signals of the steering wheel or steering column switches can also be carried out outside the steering column. By means of a suitable electrical connection, capacitances of the data processing units already present in the vehicle can be used. Of course, a division of the processing between steering wheel modules and other data processing units is also possible.

A description of exemplary embodiments using the FIGURE follows. The single FIGURE is a block diagram of steering wheel or steering column switches and of various modules in a motor vehicle.

On a steering wheel 10, which is shown schematically as a block with dash-dotted edge lines, there are various steering wheel switches, i.e. a car radio control switch 11, an on-board computer-control switch 12, a cruise control function control switch 13, a left gearshift paddle 14 for downshifting and a right gearshift paddle 15 for upshifting. The gearshift paddles 14 and 15 can be operated from the direction behind the steering wheel 10, e.g. by pushing and/or pulling with one or more fingers. Various switching schemes can be shown for this, i.e. pulling on any paddle for only upshifting, pressing on any paddle for only downshifting, or vice-versa; or pulling or pressing on one side of the steering wheel for upshifting and pulling or pressing on the other side of the steering wheel for downshifting.

The steering wheel 10 is rotatably mounted on a steering column, and the steering wheel switches 11 to 15 are electrically connected to a steering column module 20 via a coil spring cassette 21 for compensating steering wheel rotations. The steering column module 20 shown schematically as a dashed edge block comprises a steering column module electronics unit 22, an indicator steering column switch 23, e.g. disposed on the right, with which lighting functions such as e.g. dipping or headlight flasher can also be controlled, and a wiper steering column switch 24, e.g. disposed on the left, with which a fast windscreen cleaning mode can also be started. Further control elements can also mounted on the steering column and are not shown here, e.g. a gearshift lever or an electric steering column adjustment means.

The steering column module electronics unit 20 is electrically connected to various modules of the motor vehicle electronics unit 30, which is shown schematically as a block with a solid edge, i.e. with modules for body electronics 31, drive train electronics 32, multimedia electronics 33 and instrument panel electronics 34.

The electrical lines shown with thicker lines from the control switches 11 to 15 in the steering wheel 10 pass through the coil spring cassette 21 one-to-one in all cases, but not the steering column module electronics unit 22, in which partial signal processing and signal influencing take place.

In particular, filtering or plausibility checking take place in the steering column module electronics unit 22, such that a signal from the left gearshift paddle 14 is not forwarded to the motor vehicle electronics unit 30 or its drive train electronics 32 if the indicator steering column switch 23 has been operated within a certain time interval previously, e.g. in order to activate the headlight flasher. Moreover, a signal from the right gearshift paddle 15 is not forwarded if the wiper steering column switch 24 for fast windscreen cleaning has been operated within a certain time interval previously. In particular, in both cases there is a high probability that the driver has only inadvertently touched the gearshift paddle 14 or 15. This risk only exists in certain steering angle ranges, but in said exemplary embodiment the inadvertent operation of the gear shift paddles 14 or 15 is prevented independently of the steering angle. The control of the driver over the vehicle is thereby not excessively restricted.

Similarly, signals from other control switches 11 to 15 on the steering wheel 10 or from other switches on the steering column module 20 can also be forwarded to the vehicle electronics unit 30 or not depending on the operation of other steering wheel or steering column switches. For example, signals from the car radio control switches 11, the on-board computer control switches 12 and/or the cruise control switches 13 can be ignored if the steering wheel 10 is being turned rapidly, because this indicates that the driver has inadvertently operated said switch during a parking maneuver, and should not be affected by any responses of the car radio, of the on-board computer or the cruise control system. In order to be able to detect the rapid rotation of the steering wheel, the steering column module electronics unit 21 can also contain a steering angle sensor 25.

The switches whose function is temporarily disabled can be push-buttons, such as e.g. the gear shift paddles 14 and 15, or even switches with a plurality of stable switch states. In the latter case, their function can be carried out or not following the end of the disabling phase, wherein in the latter case a warning may be given that the apparently inadvertently selected function has not been carried out. If a switch with a plurality of stable switch states can be automatically reset, such as e.g. is the case with an indicator switch, use can also be made of this capability.

1. A method for case-based enabling or disabling of function of steering wheel or steering column switches in a motor vehicle,
wherein
at least one function of one of the steering wheel or steering column switches is enabled or disabled depending on operation of another steering wheel or steering column switch.

2. The method as claimed in claim 1,
wherein
the at least one function of one of the steering wheel or steering column switches is disabled in an event of the operation of one of the other steering wheel or steering column switches and that the function is enabled again at the end of the operation of the other steering wheel or steering column switch or after a predetermined time interval following the operation or the ending of the operation.

3. The method as claimed in claim 1,
wherein
the at least one function of one of the steering wheel or steering column switches is disabled and enabled independently of the current steering angle of the steering wheel.

4. The method as claimed in claim 1,
wherein
at least one switch that has a function that is enabled or disabled depending on the operation of one of the other switches is a steering wheel switch and the corresponding other switch is a steering column switch.

5. The method as claimed in claim 1,
wherein
at least one or each switch that has a function that is enabled or disabled depending on the operation of one of the other switches is to be operated from behind the steering wheel from the driver and is especially disposed on the rear of the steering wheel.

6. The method as claimed in claim 1,
wherein
at least one or each switch having a function that is enabled or disabled depending on the operation of one of the other switches is a push-button.

7. The method as claimed in claim 1,
wherein
at least one or each switch having a function that is enabled or disabled depending on the operation of one of the other switches is a control switch for a car radio, a multimedia device, an on-board computer, a cruise control system, or a gearshift paddle and wherein the corresponding other switch is an indicator steering column switch, a headlamp steering column switch, or a main beam or wiper steering column switch.

8. The method as claimed in claim 1,
wherein
the disabling or enabling by the processing of signals from the steering wheel or steering column switches is carried out in switch modules within the steering column.

9. The method as claimed in claim 1,
wherein
the disabling or enabling by the processing of signals from the steering wheel or steering column switches is carried out outside the steering column.

10. A motor vehicle with steering wheel switches and steering column switches,
wherein
a steering column of the motor vehicle contains a processing module arranged to receive signals from at least one steering wheel switch or steering column switch to at least partly process said signals, and to forward or not to forward said signals to a vehicle electronics unit depending on the operation of another steering wheel or steering column switch.

11. A motor vehicle with steering wheel switches and steering column switches,
wherein
a steering column of the motor vehicle contains a processing module is arranged for carrying out the method as claimed in claim 1.
